(19) United States
(12) Patent Application Publication
(10) Pub. No.: US 2007/0008680 A1
(43) Pub. Date: Jan. 11, 2007

(54) Power converter having housing with improved thermal properties

(76) Inventors: Agus S. The, Mesa, AZ (US); John W. Wilson, Phoenix, AZ (US)

Correspondence Address: JACKSON WALKER LLP, 901 MAIN STREET, SUITE 6000, DALLAS, TX, 75202-3797, US

(21) Appl. No.: 11/177,583

(22) Filed: Jul. 8, 2005

(51) Int. Cl. H02B 1/00

(52) U.S. Cl. 361/600

(57) ABSTRACT

A power converter housing having an internal surface evenly distributing heat therewithin to the housing. The present invention is adapted to be used in plastic housings, which housings may also include heatsinks.

### FIELD OF THE INVENTION

The present invention is generally related to power converters adapted to power portable electronic devices, and more particularly to ways of removing heat from power converters.

### BACKGROUND OF THE INVENTION

The internal components of a power converter generate heat. One of the ways to remove the heat is by using heatsink parts, such as an aluminum or copper plate with fins/blades. The heat then transfers from the component and through the heatsink via thermal conduction, convection, or both to a power supply plastic or metal case. The case dissipates the heat to the ambient. Many of the power case designs have external groves or fins to improve the removal of the heat via ambient air flow over the external features thereof.

There is desired an improved power converter having a housing adapted to extract heat and evenly distributed the heat over the entire case to enhance cooling and prevent hot spots.

### SUMMARY OF INVENTION

The present invention achieves technical advantages as a power converter having a housing with an internal surface designed to increase the internal surface area thereof and evenly distribute heat over the entire case. The present invention is adapted to be used in plastic and metal housings, in which may also contain heatsinks.

The inner surface of the housing is designed to have a plurality of inwardly extending members adapted to uniformly couple heat within the housing to the housing outer surface. Preferably, the inwardly extending members are arranged in a pattern, such as comprising a plurality of radially extending members. One or more patterns of radially extending members may be provided. In addition, some of the radially extending members may further include branching portions to evenly distribute heat, such as patterns referred to as “sun burst” or “fish bone” designs. Other designs can include parallel ribs extending vertically or horizontally. The inwardly extending members may be continuously extending members, such as ribs, but can also comprise of designs comprising spatially separated members, such as outwardly extending dimples having a half-sphere design.

### BRIEF DESCRIPTION OF THE DRAWINGS

FIG. 1 is a block diagram of a power converter seen to include a housing and an internal power converter circuit;

FIG. 2 depicts inwardly extending heat dissipating members designed on the inside major surface of the top or bottom portion of the converter housing arranged in a sun burst pattern;

FIG. 3 is a top view of the housing portion shown in FIG. 2;

FIG. 4 is a side sectional view taken along line 4-4 in FIG. 3, depicting the inwardly extending members having a thermal compound disposed therebetween;

FIG. 5 is a view of an alternative pattern of inwardly extending members arranged in a fish bone pattern;

FIG. 6 is a view of yet another pattern of the inwardly extending members comprising a plurality of spatially separated projections each comprising an outwardly extending half-sphere;

FIG. 7 is a top view of the inwardly extending members arranged in a pattern comprising vertically parallel continuous ribs;

FIG. 8 is a cross sectional view taken along line 8-8 in FIG. 7, illustrating a thermal compound disposed between the ribs;

FIG. 9 is a top view of the inwardly extending members arranged as horizontally parallel ribs; and

FIG. 10 is a side sectional view of a power converter having an upper inner surface including the ribs of FIG. 7 and further shown to be integrated with a heatsink thermally coupled to a circuit component generating heat and coupled to a printed circuit board disposed within the housing.

### DETAILED DESCRIPTION OF THE PRESENT INVENTION

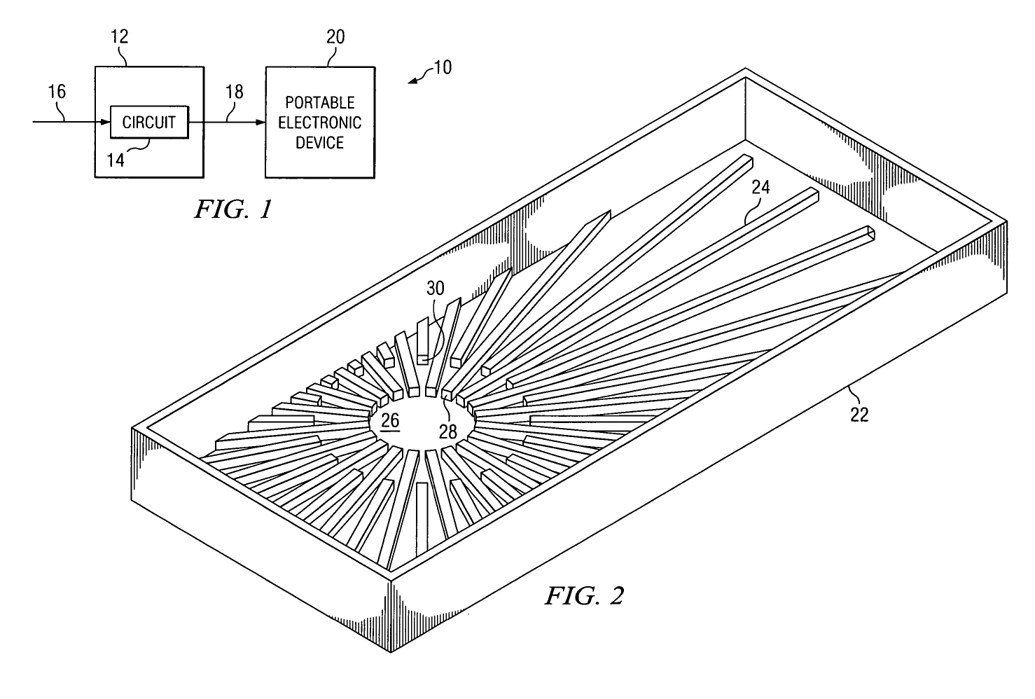

Referring now to FIG. 1, there is shown an electronic block diagram of a power converter 10 seen to have a housing 12 defining a cavity encompassing therewithin a power converter circuitry 14. Circuitry 14 is adapted to receive a power source at input 16 and provide a converted power output at 18 adapted to power a portable electronic device 20. Converter 10 may be configured to receive an AC input voltage at 16, a DC input voltage, or both. The output provided at 18 is preferably a DC voltage and current adapted to power the portable electronic device 20, but which may also comprise of an AC voltage and current if desired. Power converter circuit 14 generates substantial heat within housing 12 during operation, which heat needs to be conveyed to housing 10 for release to the ambient. The output voltage and current provided to output 18 may be programmable, such as utilizing programming tips provided by Mobility Electronics, Inc., of Scottsdale Ariz., currently branded as the iTip™, the owner of the present invention. Other suitable programming methodologies can be utilized such as rotary dials coupled to potentiometers, and programming switches.

Referring now to FIG. 2, there is shown a perspective view of a bottom housing portion 22 comprising a portion of housing 12, seen to include inwardly extending members 24 adapted to thermally transfer and uniformly spread internal heat within the housing 10 to housing 12. In this embodiment, the inwardly extending members 24 are shown arranged as a plurality of elongated ribs extending radially outward from a central housing portion 26 that may be disposed proximate an internal component of circuit 14 generating significant heat. The inwardly extending members 24 are shown to be arranged in a “sun burst” pattern, and are seen to comprise of a first pattern having members terminating at the inner most portion 28 of the design. A second radial pattern of members 24 is seen to extend radially outward from an outer portion 30 disposed further away from portion 26 than portion 28. This second pattern is also designed in a sun burst pattern, and comprises radially extending members 24 interposed between the members 24 of the first pattern, thereby advantageously providing significant surface area to remove heat from within the housing 12. The side and top portions of each member 24 increases the overall surface area by which internal heat can be communicated to the members 24 and uniformly communicated to the outer surface of housing 12 for release into the ambient. The design uniformly distributes heat throughout the entire outer surface of housing 12 to reduce or eliminate a hot spot on an outer surface of housing 12.

As shown in FIG. 2, the radially extending members 24 are tightly packed, yet separated from each other, to maximize the surface area exposed to the internal heated air. If desired, the inner ends at 28 of the first pattern may be in physical contact with each other, such as arranged to form a hub, with the radially extending members 24 forming spokes. Some or all of the radially extending members 24 may be further interconnected to each with additional laterally extending members forming additional annular members, forming a “web” design.

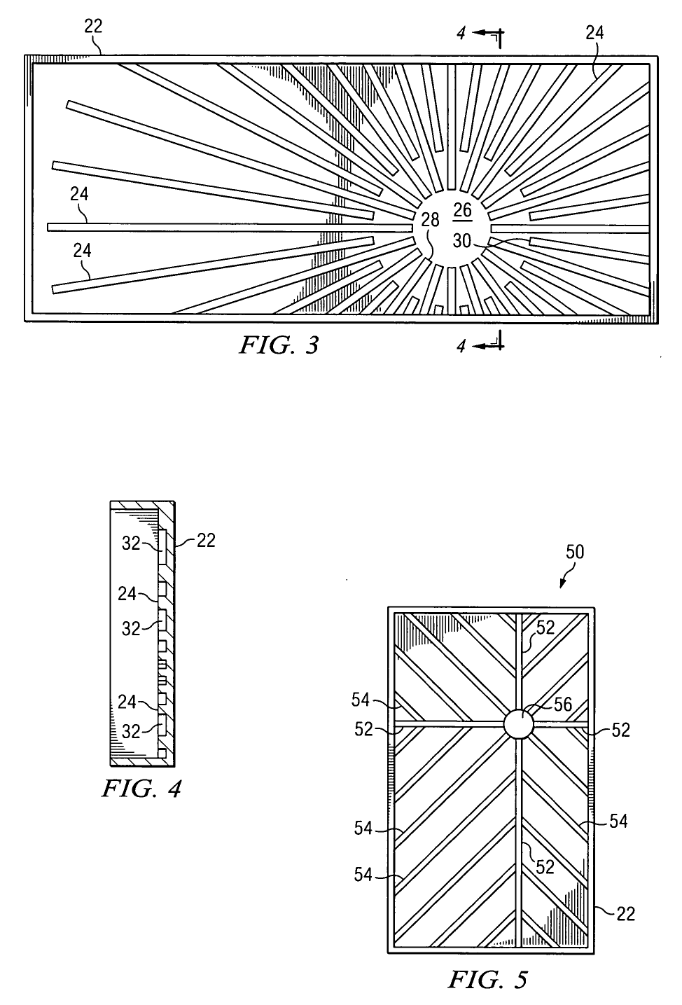

Referring to FIG. 3, there is shown a top view of the member pattern of FIG. 2, with portion 26 adapted to be disposed very closely proximate a heated component of circuit 14, such as a power transistor.

FIG. 4 shows a cross sectional view taken along line 4-4 in FIG. 3, illustrating the portions between the inwardly extending members 24 being filled with a thermal compound 32 to further increase pulling heat from heat sources within the housing 12. This thermal compound is disposed between the inwardly extending members 24 and any other laterally extending members if utilized, as previously described. The purpose of the radially extending members 24 is to uniformly direct heat radially outward as quickly as possible and to provide generally uniform heat to the outside portion of the housing, and prevent a hot spot.

Referring now to FIG. 5, there is shown at 50 another pattern of inwardly extending members similar to radially extending members 24, seen to comprise of inwardly extending members 52 and 54 arranged in a “fish bone” pattern. The radially extending members 52 extend from a portion 56 adapted to be disposed proximate a high heat source, with the additional members 54 branching away from each of these radially extending members 52. Each of these laterally extending members 52 and 54 are seen to diverge outwardly and away from portion 56. Thermal compound 32 is disposed between the members.

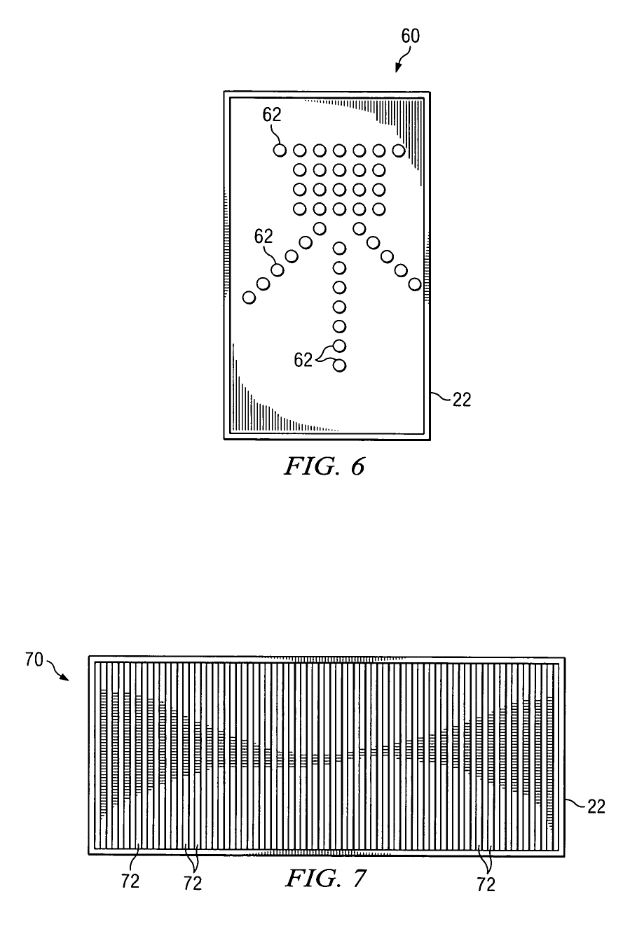

FIG. 6 depicts yet another member pattern at 60 comprising a pattern of discrete inwardly extending members 62 spatially separated from one another, each member being adapted to communicate heat to the underlying portion of the housing member 22. Each inwardly extending member 62 may be designed in a shape of a half-sphere, providing maximum surface area offered by a sphere for each given portion. These half-sphere members may also be utilized in place of some elongated rib members previously described, such as members 24, 52 and 54.

Referring now to FIG. 7, there is shown a top view of yet another embodiment of the present invention seen to comprise of housing portion 22 having inwardly extending vertically parallel members 72. Each member 72 extends inwardly towards the circuit 12 when assembled with the remaining portion of housing 14.

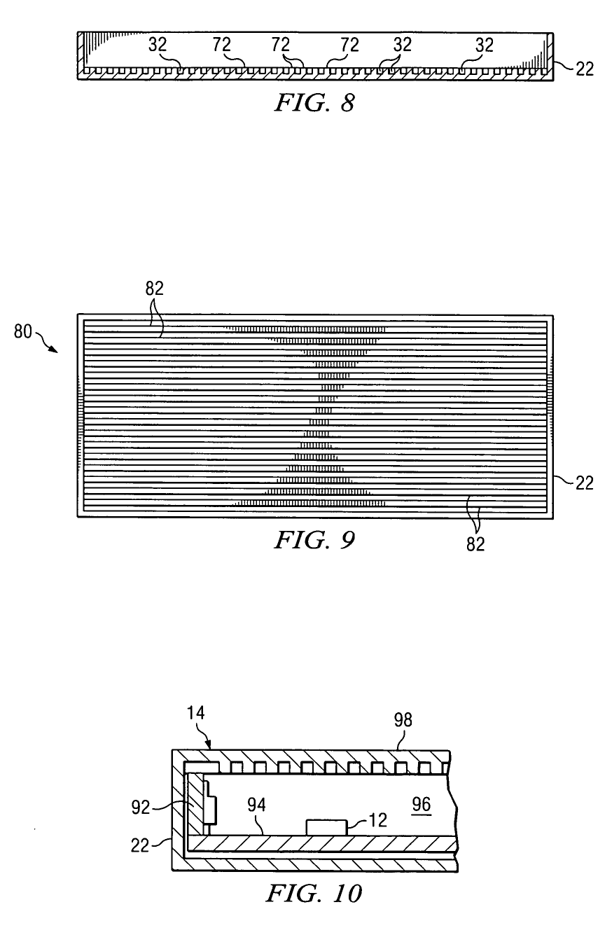

Referring to FIG. 8, there is shown a side sectional view taken along line 8-8 of FIG. 7 seen to show the thermal compound 22 disposed between the rib portions 72. As shown, these ribs extend vertically, but could also be designed to extend horizontally if desired. As shown at 80 with members 82 in FIG. 9. Again, this pattern of inwardly extending members 72 and 82 facilitates uniformly transferring heat from within the housing 12 to the outer surface of the housing to prevent or reduce hotspots on the outer portion of the housing 12.

Referring to FIG. 10, there is shown yet another embodiment of the present invention seen to show the converter 10 having housing portion 22 including the rib members 72 of FIG. 7, further arranged to cooperate with a heatsink 90 in physical communication thereof. Heatsink 90 is seen to extend between the housing portion 22 and a printed circuit board 94 including circuit 14 and disposed within housing 12 of converter 10. The inwardly extending members 72 further cooperate with the heatsink 90 to maximize the thermal transfer of heat within the housing 12, shown in cavity 96, to the outer surface 98 of housing 12.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A power converter, comprising:
a circuit adapted to convert an input voltage received at an input to an output voltage at an output; and
a housing encompassing the circuit and having an inner surface and an outer surface, the inner surface having a plurality of inwardly extending members adapted to uniformly couple heat within the housing to the housing outer surface.

2. The power converter as specified in claim 1 wherein the members are arranged in a pattern.

3. The power converter as specified in claim 2 wherein the members radially extend from a first portion of the housing.

4. The power converter as specified in claim 3 wherein the radially extending members are arranged in a plurality of radial patterns.

5. The power converter as specified in claim 3 wherein several of the radially extending members have peripheral members laterally extending therefrom.

6. The power converter as specified in claim 5 wherein the peripheral members diverge away from the housing first portion.

7. The power converter as specified in claim 3 wherein the members are elongated.

8. The power converter as specified in claim 3 wherein the members comprise of a series of individual protrusions.

9. The power converter as specified in claim 8 wherein the protrusions comprise outwardly rounded surfaces.

10. The power converter as specified in claim 2 wherein the members are parallel to one another.

11. The power converter as specified in claim 10 wherein the members comprise of a series of individual protrusions.

12. The power converter as specified in claim 11 wherein the protrusions comprise outwardly rounded surfaces.

13. The power converter as specified in claim 10 wherein the members are elongated.

14. The power converter as specified in claim 1 further comprising a heatsink disposed within the housing and thermally coupled to at least one component of the circuit, wherein some of members are mechanically coupled to the heatsink.

15. The power converter as specified in claim 1 further comprising a heatsink disposed within the housing and thermally coupled to at least one component of the circuit, wherein the members are spatially coupled to the heatsink.

16. The power converter as specified in claim 1 further comprising a thermal compound disposed between at least some of the members
